(19) United States
(12) Patent Application Publication
(10) Pub. No.: US 2025/0126512 A1
(43) Pub. Date: Apr. 17, 2025

(54) SELECTION OF QOS PROFILES BASED ON ENERGY CONSIDERATIONS

(71) Applicant: Samsung Electronics Co., Ltd., Suwon-si (KR)

(72) Inventors: Chadi KHIRALLAH, Staines (GB); Mahmoud WATFA, Staines (GB); Erik GUTTMAN, Staines (GB)

(21) Appl. No.: 18/909,089

(22) Filed: Oct. 8, 2024

(30) Foreign Application Priority Data
Oct. 11, 2023 (GB) 2315596.3
Jun. 27, 2024 (GB) 2409312.2

(51) Int. Cl. H04W 28/02; H04W 52/36

(52) U.S. Cl. CPC H04W 28/0268; H04W 52/367

(57) ABSTRACT

The disclosure relates to a 5^{th} generation (5G) or 6^{th} generation (6G) communication system for supporting a higher data transmission rate. A method performed by a network entity in a wireless communications network is provided. The method includes obtaining energy information associated with the wireless communications network and determining, based on the energy information, at least one of a quality of service (QoS) profile associated with a QoS flow of the wireless communications network and a QoS profile associated with a user equipment (UE).

### CROSS-REFERENCE TO RELATED APPLICATION(S)

This application is based on and claims priority under 35 U.S.C. § 119(a) of a United Kingdom patent application number 2315596.3, filed on Oct. 11, 2023, in the United Kingdom Intellectual Property Office, and of a United Kingdom patent application number 2409312.2, filed on Jun. 27, 2024, in the United Kingdom Intellectual Property Office, the disclosure of each of which is incorporated by reference herein in its entirety.

### BACKGROUND

### 1. Field

The disclosure relates to one or more techniques for selection of quality of service (QoS) profiles based on energy considerations. More particularly, the disclosure relates to techniques for selection of QoS profiles in a 3^{rd} generation partnership project (3GPP) 5^{th} generation (5G) new radio (NR) network.

### 2. Description of Related Art

5G mobile communication technologies define broad frequency bands such that high transmission rates and new services are possible, and can be implemented not only in “Sub 6 GHz” bands, such as 3.5 GHz, but also in “Above 6 GHz” bands referred to as mmWave including 28 GHz and 39 GHz. In addition, it has been considered to implement 6th generation (6G) mobile communication technologies (referred to as beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as Industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Herein, the following documents may be referenced:
[1] 3GPP TR 22.882 V0.2.0 (2022 November), 3^{rd} Generation Partnership Project; Technical Specification Group TSG SA; Study on Energy Efficiency as service criteria (Release 19).
[2] 3GPP TS 23.501 V18.3.0.
[3] 3GPP TS 24.501 V18.1.0.
[4] 3GPP TS 38.413 V17.5.0.
   Ongoing 3GPP study in SA1 on ‘Energy Efficiency as Service Criteria’

The 3GPP SA1 groups is currently studying how to introduce energy efficiency as a service and this is documented in 3GPP TR 22.882 V0.2.0 [1]. The overview of the study as defined in [1] is provided below:

“Climate change and globally energy shortage are issues that requires international cooperation and coordinated solutions at all levels, many regions and countries have published related policies and requirements to control carbon release and promote energy efficiency. These policies have made energy efficiency a strategic priority for many telecoms operators around the world. Energy efficiency has been considered in many standard groups and specifications.

The existing studies concentrate more on how to satisfy user experience and try to achieve energy efficiency at the same time and achieve energy efficiency within the network, so the requirements, use cases and solutions are basically within the network itself. Verticals and customers have no approach for energy efficiency related information from network.

Introducing energy efficiency as a service will allow users to have the choice to select proper energy efficiency criteria as well as other network performance parameters when they need it, which may include:

Define and support energy efficiency criteria as part of communication service to user and application services.

Provide information exposure on systematic energy consumption or level of energy efficiency to vertical customers.

Such as in satellite and terrestrial convenience scenario, for some regions where both satellite and terrestrial coverage exist, energy saving could be taken as a dimension while providing the communication service, users or operators could have the choice to find out a best way in satisfying both user experience and energy efficiency. From another perspective, the network could also react to different energy consumption modes of application or adjust network resource.

Both the two aspects above need more interaction between application and network on energy consumption status. It is worth considering how to deliver services with energy efficiency as service criteria, associated with verticals' preferences, and how to support the policy of handling energy as part of a subscription.”

The study also contains use cases for which potential requirement may be defined. One of the use cases focuses on using energy as a performance criteria (for best effort communication). The use case is provided in section 5.1 of [1] and is as follows:

“A large scale logistics company L has deployed a large number of communicating components. These are integrated into vehicles, palettes, facilities, or the like. Essentially, IoT terminals enable remote tracking and monitoring functions. The information gathered is relevant, but not constrained with respect to latency. In fact, eventual delivery (e.g., after hours or even a full day) of communication is entirely acceptable for L. The MNO M offers a ‘green service’ which limits the rate of energy utilized for communication over a particular time interval (e.g., per day) and this service is appropriate for L, whose overall corporate goals are also served by ‘green service,’ as they strive to operate with energy efficiency.”

Admitting QoS flows in the Next Generation (NG)—Radio Access Network (RAN)

As part of the overall QoS framework, the 5G System (5GS) can provide so called guaranteed bit rate (GBR) QoS flows which means that the characteristics of the QoS flow can be guaranteed in the NG-RAN (at least) and the network. The profile of a QoS is provided below from [2]:

A QoS Flow may either be ‘GBR’ or ‘Non-GBR’ depending on its QoS profile. The QoS profile of a QoS Flow is sent to the (R)AN and it contains QoS parameters as described below (details of QoS parameters are described in clause 5.7.2):
For each QoS Flow, the QoS profile shall include the QoS parameters:

5G QoS identifier (5QI); and
Allocation and retention priority (ARP).
For each QoS Flow, the QoS profile may also include the QoS parameters:
Protocol data unit (PDU) Set QoS parameters (described in clause 5.7.7).
For each non-GBR QoS Flow only, the QoS profile may also include the QoS parameter:
Reflective QoS attribute (RQA).
For each GBR QoS Flow only, the QoS profile shall also include the QoS parameters:
Guaranteed flow bit rate (GFBR)—uplink (UL) and downlink (DL); and
Maximum flow bit rate (MFBR)—UL and DL; and
In the case of a GBR QoS Flow only, the QoS profile may also include one or more of the QoS parameters:
Notification control;
Maximum Packet Loss Rate—UL and DL.

The characteristics of QoS are determined by a set of parameters as shown in the table below from [2].

The table shows the characteristics for GBR flows vs non-GBR flows, each of which is associated with a standardized 5QI.

| | | | | | Default | | |
|---|---|---|---|---|---|---|---|
| | | | Packet | | Maximum | | |
| | | | Delay | | Data Burst | | |
| | | Default | Budget | Packet | Volume | Default | |
| 5QI | Resource | Priority | (PDB) | Error | (MDBV) | Averaging | Example |
| Value | Type | Level | (NOTE 3) | Rate | (NOTE 2) | Window | Services |
| 1 | GBR | 20 | 100 ms | 10⁻² | N/A | 2000 ms | Conversational |
| | (NOTE 1) | | (NOTE 11, | | | | Voice |
| | | | NOTE 13) | | | | |
| 2 | | 40 | 150 ms | 10⁻³ | N/A | 2000 ms | Conversational |
| | | | (NOTE 11, | | | | Video |
| | | | NOTE 13) | | | | (Live |
| | | | | | | | Streaming) |
| 3 | | 30 | 50 ms | 10⁻³ | N/A | 2000 ms | Real Time |
| | | | (NOTE 11, | | | | Gaming, V2X |
| | | | NOTE 13) | | | | messages (see |
| | | | | | | | TS 23.287 [121]). |
| | | | | | | | Electricity |
| | | | | | | | distribution - |
| | | | | | | | medium |
| | | | | | | | voltage, |
| | | | | | | | Process |
| | | | | | | | automation |
| | | | | | | | monitoring |
| 4 | | 50 | 300 ms | 10⁻⁶ | N/A | 2000 ms | Non- |
| | | | (NOTE 11, | | | | Conversational |
| | | | NOTE 13) | | | | Video |
| | | | | | | | (Buffered |
| | | | | | | | Streaming) |
| 65 | | 7 | 75 ms | 10⁻² | N/A | 2000 ms | Mission |
| (NOTE 9, | | | (NOTE 7, | | | | Critical user |
| NOTE 12) | | | NOTE 8) | | | | plane Push To |
| | | | | | | | Talk voice |
| | | | | | | | (e.g., MCPTT) |
| 66 | | 20 | 100 ms | 10⁻² | N/A | 2000 ms | Non-Mission- |
| (NOTE 12) | | | (NOTE 10, | | | | Critical user |
| | | | NOTE 13) | | | | plane Push To |
| | | | | | | | Talk voice |
| 67 | | 15 | 100 ms | 10⁻³ | N/A | 2000 ms | Mission |
| (NOTE 12) | | | (NOTE 10, | | | | Critical Video |
| | | | NOTE 13) | | | | user plane |
| 75 | | 25 | 50 ms | 10⁻² | N/A | 2000 ms | V2X messages |
| (NOTE 14) | | | (NOTE 13) | | | | (see |
| | | | | | | | TS 23.287 [121]). |
| | | | | | | | A2X messages |
| | | | | | | | (see |
| | | | | | | | TS 23.256 [136]) |
| 71 | | 56 | 150 ms | 10⁻⁶ | N/A | 2000 ms | “Live” Uplink |
| | | | (NOTE 11, | | | | Streaming |
| | | | NOTE 13, | | | | (e.g., |
| | | | NOTE 15) | | | | TS 26.238 [76]) |
| 72 | | 56 | 300 ms | 10⁻⁴ | N/A | 2000 ms | “Live” Uplink |
| | | | (NOTE 11, | | | | Streaming |
| | | | NOTE 13, | | | | (e.g., |
| | | | NOTE 15) | | | | TS 26.238 [76]) |
| 73 | | 56 | 300 ms | 10⁻⁸ | N/A | 2000 ms | “Live” Uplink |
| | | | (NOTE 11, | | | | Streaming |
| | | | NOTE 13, | | | | (e.g., |
| | | | NOTE 15) | | | | TS 26.238 [76] |
| 74 | | 56 | 500 ms | 10⁻⁸ | N/A | 2000 ms | “Live” Uplink |
| | | | (NOTE 11, | | | | Streaming |
| | | | NOTE 15) | | | | (e.g., |
| | | | | | | | TS 26.238 [76]) |
| 76 | | 56 | 500 ms | 10⁻⁴ | N/A | 2000 ms | “Live” Uplink |
| | | | (NOTE 11, | | | | Streaming |
| | | | NOTE 13, | | | | (e.g., |
| | | | NOTE 15) | | | | TS 26.238 [76]) |
| 5 | Non-GBR | 10 | 100 ms | 10⁻⁶ | N/A | N/A | IMS Signalling |
| | | | NOTE 10, | | | | |
| | | | NOTE 13) | | | | |
| 6 | (NOTE 1) | 60 | 300 ms | 10⁻⁶ | N/A | N/A | Video |
| | | | (NOTE 10, | | | | (Buffered |
| | | | NOTE 13) | | | | Streaming) |
| | | | | | | | transmission |
| | | | | | | | control |
| | | | | | | | protocol |
| | | | | | | | (TCP)-based |
| | | | | | | | (e.g., www, e- |
| | | | | | | | mail, chat, file |
| | | | | | | | transfer |
| | | | | | | | protocol (ftp), |
| | | | | | | | peer-to-peer |
| | | | | | | | (p2p) file |
| | | | | | | | sharing, |
| | | | | | | | progressive |
| | | | | | | | video, or the |
| | | | | | | | like), AI/ML |
| | | | | | | | model |
| | | | | | | | download for |
| | | | | | | | image |
| | | | | | | | recognition |
| | | | | | | | (e.g., for model |
| | | | | | | | topology) (see |
| | | | | | | | TS 22.261 [2]) |
| 7 | | 70 | 100 ms | 10⁻³ | N/A | N/A | Voice, |
| | | | (NOTE 10, | | | | Video (Live |
| | | | NOTE 13) | | | | Streaming) |
| | | | | | | | Interactive |
| | | | | | | | Gaming, |
| | | | | | | | AI/ML model |
| | | | | | | | download for |
| | | | | | | | image |
| | | | | | | | recognition |
| | | | | | | | (e.g., for model |
| | | | | | | | weight factors) |
| | | | | | | | (see |
| | | | | | | | TS 22.261 [2]) |
| 8 | | 80 | 300 ms | 10⁻⁶ | N/A | N/A | Video |
| | | | (NOTE 13) | | | | (Buffered |
| | | | | | | | Streaming) |
| | | | | | | | TCP-based |
| | | | | | | | (e.g., www, e- |
| | | | | | | | mail, chat, ftp, |
| | | | | | | | p2p file |
| | | | | | | | sharing, |
| | | | | | | | progressive |
| 9 | | 90 | | | | | video, or the |
| | | | | | | | like) |
| 10 | | 90 | 1100 ms | 10⁻⁶ | N/A | N/A | Video |
| | | | (NOTE 13) | | | | (Buffered |
| | | | (NOTE 17) | | | | Streaming) |
| | | | | | | | TCP-based |
| | | | | | | | (e.g., www, e- |
| | | | | | | | mail, chat, ftp, |
| | | | | | | | p2p file |
| | | | | | | | sharing, |
| | | | | | | | progressive |
| | | | | | | | video, or the |
| | | | | | | | like) and any |
| | | | | | | | service that can |
| | | | | | | | be used over |
| | | | | | | | satellite access |
| | | | | | | | type with these |
| | | | | | | | characteristics |
| 69 | | 5 | 60 ms | 10⁻⁶ | N/A | N/A | Mission |
| (NOTE 9, | | | (NOTE 7, | | | | Critical delay |
| NOTE 12) | | | NOTE 8) | | | | sensitive |
| | | | | | | | signalling (e.g., |
| | | | | | | | MC-PTT |
| | | | | | | | signalling) |
| 70 | | 55 | 200 ms | 10⁻⁶ | N/A | N/A | Mission |
| (NOTE 12) | | | (NOTE 7, | | | | Critical Data |
| | | | NOTE 10) | | | | (e.g., example |
| | | | | | | | services are the |
| | | | | | | | same as 5QI |
| | | | | | | | 6/8/9) |
| 79 | | 65 | 50 ms | 10⁻² | N/A | N/A | V2X messages |
| | | | (NOTE 10, | | | | (see |
| | | | NOTE 13) | | | | TS 23.287 [121]) |
| 80 | | 68 | 10 ms | 10⁻⁶ | N/A | N/A | Low Latency |
| | | | (NOTE 5, | | | | eMBB |
| | | | NOTE 10) | | | | applications |
| | | | | | | | Augmented |
| | | | | | | | Reality |
| 82 | Delay- | 19 | 10 ms | 10⁻⁴ | 255 bytes | 2000 ms | Discrete |
| 83 | critical | 22 | (NOTE 4) | 10⁻⁴ | 1354 bytes | 2000 ms | Automation |
| | GBR | | 10 ms | | (NOTE 3) | | (see |
| | | | (NOTE 4) | | | | TS 22.261 [2]) |
| | | | | | | | Discrete |
| | | | | | | | Automation |
| | | | | | | | (see |
| | | | | | | | TS 22.261 [2]); |
| | | | | | | | V2X messages |
| | | | | | | | (UE - roadside |
| | | | | | | | unit (RSU) |
| | | | | | | | Platooning, |
| | | | | | | | Advanced |
| | | | | | | | Driving: |
| | | | | | | | Cooperative |
| | | | | | | | Lane Change |
| | | | | | | | with low LoA. |
| | | | | | | | See |
| | | | | | | | TS 22.186 [111], |
| | | | | | | | TS 23.287 [121]) |
| 84 | | 24 | 30 ms | 10⁻⁵ | 1354 bytes | 2000 ms | Intelligent |
| | | | (NOTE 6) | | (NOTE 3) | | transport |
| | | | | | | | systems (see |
| | | | | | | | TS 22.261 [2]) |
| 85 | | 21 | 5 ms | 10⁻⁵ | 255 bytes | 2000 ms | Electricity |
| | | | (NOTE 5) | | | | Distribution- |
| | | | | | | | high voltage |
| | | | | | | | (see |
| | | | | | | | TS 22.261 [2]). |
| | | | | | | | V2X messages |
| | | | | | | | (Remote |
| | | | | | | | Driving. See |
| | | | | | | | TS 22.186 [111], |
| | | | | | | | NOTE 16, |
| | | | | | | | see |
| | | | | | | | TS 23.287 [121]). |
| | | | | | | | Split AI/ML |
| | | | | | | | inference - DL |
| | | | | | | | Split AI/ML |
| | | | | | | | image |
| | | | | | | | recognition, |
| | | | | | | | (see |
| | | | | | | | TS 22.261 [2]) |
| 86 | | 18 | 5 ms | 10⁻⁴ | 1354 bytes | 2000 ms | V2X messages |
| | | | (NOTE 5) | | | | (Advanced |
| | | | | | | | Driving: |
| | | | | | | | Collision |
| | | | | | | | Avoidance, |
| | | | | | | | Platooning with |
| | | | | | | | high LoA. See |
| | | | | | | | TS 22.186 [111], |
| | | | | | | | TS 23.287 [121]) |
| 87 | | 25 | 5 ms | 10⁻³ | 500 bytes | 2000 ms | Interactive |
| | | | (NOTE 4) | | | | Service - |
| | | | | | | | Motion |
| | | | | | | | tracking data, |
| | | | | | | | (see |
| | | | | | | | TS 22.261 [2]) |
| 88 | | 25 | 10 ms | 10⁻³ | 1125 bytes | 2000 ms | Interactive |
| | | | (NOTE 4) | | | | Service - |
| | | | | | | | Motion |
| | | | | | | | tracking data, |
| | | | | | | | (see |
| | | | | | | | TS 22.261 [2]), |
| | | | | | | | split AI/ML |
| | | | | | | | inference - UL |
| | | | | | | | Split AI/ML |
| | | | | | | | image |
| | | | | | | | recognition, |
| | | | | | | | (see |
| | | | | | | | TS 22.261 [2]) |
| 89 | | 25 | 15 ms | 10⁻⁴ | 17000 bytes | 2000 ms | Visual content |
| | | | (NOTE 4) | | | | for |
| | | | | | | | cloud/edge/split |
| | | | | | | | rendering (see |
| | | | | | | | TS 22.261 [2]) |
| 90 | | 25 | 20 ms | 10⁻⁴ | 63000 bytes | 2000 ms | Visual content |
| | | | (NOTE 4) | | | | for |
| | | | | | | | cloud/edge/split |
| | | | | | | | rendering (see |
| | | | | | | | TS 22.261 [2]) |

NOTE 1:
A packet which is delayed more than PDB is not counted as lost, thus not included in the packet error rate (PER).
NOTE 2:
It is required that default MDBV is supported by a PLMN supporting the related 5QIs.
NOTE 3:
The Maximum Transfer Unit (MTU) size considerations in clause 9.3 and Annex C of TS 23.060 [56] are also applicable. IP fragmentation may have impacts to core network (CN) PDB, and details are provided in clause 5.6.10.
NOTE 4:
A static value for the CN PDB of 1 ms for the delay between a user plane function (UPF) terminating N6 and a 5G-AN should be subtracted from a given PDB to derive the packet delay budget that applies to the radio interface. When a dynamic CN PDB is used, see clause 5.7.3.4.
NOTE 5:
A static value for the CN PDB of 2 ms for the delay between a UPF terminating and a 5G-AN should be subtracted from a given PDB to derive the packet delay budget that applies to the radio interface. When a dynamic CN PDB is used, see clause 5.7.3.4.
NOTE 6:
A static value for the CN PDB of 5 ms for the delay between a UPF terminating N6 and a 5G-AN should be subtracted from a given PDB to derive the packet delay budget that applies to the radio interface. When a dynamic CN PDB is used, see clause 5.7.3.4.
NOTE 7:
For Mission Critical services, it may be assumed that the UPF terminating N6 is located “close” to the 5G_AN (roughly 10 ms) and is not normally used in a long distance, home routed roaming situation. Hence a static value for the CN PDB of 10 ms for the delay between a UPF terminating N6 and a 5G_AN should be subtracted from this PDB to derive the packet delay budget that applies to the radio interface. In both RRC_IDLE and RRC_CONNECTED mode, the PDB requirement for 5QIs can be relaxed (but not to a value greater than 320 ms) for the first packet(s) in a downlink data or signalling burst in order to permit reasonable battery saving (DRX) techniques.
NOTE 8:
In both RRC_IDLE and RRC_CONNECTED mode, the PDB requirement for these 5QIs can be relaxed (but not to a value greater than 320 ms) for the first packet(s) in a downlink data or signalling burst in order to permit reasonable battery saving (DRX) techniques.
NOTE 9:
It is expected that 5Q1-65 and 5QI-69 are used together to provide Mission Critical Push to Talk service (e.g., 5Q1-5 is not used for signalling). It is expected that the amount of traffic per UE will be similar or less compared to the IMS signalling.
NOTE 10:
In both RRC_IDLE and RRC_CONNECTED mode, the PDB requirement for these 5QIs can be relaxed for the first packet(s) in a downlink data or signalling burst in order to permit battery saving (DRX) techniques.
NOTE 11:
In RRC_IDLE mode, the PDB requirement for these 5QIs can be relaxed for the first packet(s) in a downlink data or signalling burst in order to permit battery saving (DRX) techniques.
NOTE 12:
This 5QI value can only be assigned upon request from the network side. The UE and any application running on the UE is not allowed to request this 5QI value.
NOTE 13:
A static value for the CN PDB of 20 ms for the delay between a UPF terminating N6 and a 5G-AN should be subtracted from a given PDB to derive the packet delay budget that applies to the radio interface.
NOTE 14:
This 5QI is only used for transmission of V2X messages as defined in TS 23.287 [121] and transmission of A2X messages as defined in TS 23.256 [136].
NOTE 15:
For “live” uplink streaming (see TS 26.238 [76]), guidelines for PDB values of the different 5QIs correspond to the latency configurations defined in TR 26.939 [77]. In order to support higher latency reliable streaming services (above 500 ms PDB), if different PDB and PER combinations are needed these configurations will have to use non-standardised 5QIs.
NOTE 16:
These services are expected to need much larger MDBV values to be signalled to the RAN. Support for such larger MDBV values with low latency and high reliability is likely to require a suitable RAN configuration, for which, the simulation scenarios in TR 38.824 [112] may contain some guidance.
NOTE 17:
The worst case one way propagation delay for GEO satellite is expected to be ~270 ms, , ~21 ms for LEO at 1200 km, and 13 ms for LEO at 600 km. The UL scheduling delay that needs to be added is also typically two way propagation delay e.g., ~540 ms for GEO, ~42 ms for LEO at 1200 km, and ~ 26 ms for LEO at 600 km. Based on that, the 5G-AN Packet delay budget is not applicable for 5QIs that require 5G-AN PDB lower than the sum of these values when the specific types of satellite access are used (see TS 38.300 [27]). 5Q1-10 can accommodate the worst case PDB for GEO satellite type.

When the network attempts to establish a new QoS flow, either based on a request for a new protocol data unit (PDU) session establishment or based on a modification of an existing PDU session, then the NG-RAN verifies if a new QoS flow can be admitted. This is especially crucial when the QoS requested is for a GBR QoS flow since admission of a guaranteed bit rate necessitates that the NG-RAN continuously provides the required treatment as long as there is associated data.

One parameter which is associated with a QoS flow is referred to as allocation and retention priority (ARP) which is described below from [2]:

The QoS parameter ARP contains information about the priority level, the pre-emption capability and the pre-emption vulnerability. This allows deciding whether a QoS Flow establishment/modification/handover may be accepted or needs to be rejected in the case of resource limitations (typically used for admission control of GBR traffic). It may also be used to decide which existing QoS Flow to pre-empt during resource limitations, i.e., which QoS Flow to release to free up resources.

The ARP priority level defines the relative importance of a QoS Flow. The range of the ARP priority level is 1 to 15 with 1 as the highest priority.

The ARP priority levels 1-8 should only be assigned to QoS Flows for services that are authorized to receive prioritized treatment within an operator domain (i.e., that are authorized by the serving network). The ARP priority levels 9-15 may be assigned to QoS Flows for services that are authorized by the home network and thus applicable when a UE is roaming.

NOTE: This ensures that future releases may use ARP priority level 1-8 to indicate e.g., emergency and other priority services within an operator domain in a backward compatible manner. This does not prevent the use of ARP priority level 1-8 in roaming situation in the case that appropriate roaming agreements exist that ensure a compatible use of these priority levels.

The ARP pre-emption capability defines whether a QoS Flow may get resources that were already assigned to another QoS Flow with a lower priority. The ARP pre-emption vulnerability defines whether a QoS Flow may lose the resources assigned to it in order to admit a QoS Flow with higher priority. The ARP pre-emption capability and the ARP pre-emption vulnerability shall be either set to ‘enabled’ or ‘disabled’.

The ARP pre-emption vulnerability of the QoS Flow which the default QoS rule is associated with should be set appropriately to minimize the risk of a release of this QoS Flow.

The details of how the session management function (SMF) sets the ARP for a QoS Flow are further described in clause 5.7.2.7

From the above, it can be seen that admission of a new GBR QoS flow requires the NG-RAN to verify if resources can be reserved and guaranteed for the flow and the NG-RAN considers the ARP of existing QoS flows to determine which QoS flow may be pre-empted when resources are scarce.

### Alternative QoS Profile

3GPP introduced the concept of Alternative QoS Profile(s) that is provided to the NG-RAN for a given GBR QoS Flow. The idea is that if the NG-RAN is not able to fulfil, for example, in terms of the resources needed, the QoS requirements (i.e., QoS profile) set (by the network) for a given QoS Flow, the NG-RAN may try to use the QoS requirements for an alternative QoS Profile for the given QoS Flow. The NG-RAN informs the network (e.g., SMF) that it can fulfil the alternative QoS profile for the QoS Flow. The following is described in 5.7.1.2a of [2]:

### Alternative QoS Profile

The alternative QoS profile(s) can be optionally provided for a GBR QoS Flow with Notification control enabled. If the corresponding policy and charging control (PCC) rule contains the related information (as described in TS 23.503 [45]), the SMF shall provide, in addition to the QoS profile, a prioritized list of Alternative QoS Profile(s) to the NG-RAN. If the SMF provides a new prioritized list of Alternative QoS Profile(s) to the NG-RAN (if the corresponding PCC rule information changes), the NG-RAN shall replace any previously stored list with it.

An Alternative QoS Profile represents a combination of QoS parameters PDB, PER, Averaging Window and GFBR to which the application traffic is able to adapt. For delay-critical GBR QoS flows, an Alternative QoS Profile may also include an MDBV.

NOTE 1: There is no requirement that the GFBR monotonically decreases, nor that the PDB or PER monotonically increase as the Alternative QoS Profiles become less preferred.

When the NG-RAN sends a notification to the SMF that the QoS profile is not fulfilled, the NG-RAN shall, if the currently fulfilled values match an Alternative QoS Profile, include also the reference to the Alternative QoS Profile to indicate the QoS that the NG-RAN currently fulfils (see clause 5.7.2.4). The NG-RAN shall enable the SMF to determine when an NG-RAN node supports the Alternative QoS feature but cannot fulfil even the least preferred Alternative QoS Profile.

NOTE 2: To reduce the risk that GBR QoS Flows are released in case of RAN resource limitations (and then experience difficulties in being re-established), Application Functions can set the least preferred Alternative Service Requirement to an undemanding level.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide energy efficiency or energy saving in a network at a granularity of quality of service (QoS) flow.

Another aspect of the disclosure is to provide a method and apparatus for actions to handle energy consumption per user equipment (UE) at the granularity of QoS flow and actions to handle QoS profile or alternative QoS profile based on energy considerations.

Additional aspects will be set forth in part in the description which follows and, in part, will be apparent from the description, or may be learned by practice of the presented embodiments.

In accordance with an aspect of the disclosure, a method performed by a network entity in a wireless communications network is provided. The method includes obtaining energy information associated with the wireless communications network, and determining, based on the energy information, at least one of a QoS profile associated with a QoS flow of the wireless communications network and a QoS profile associated with a user equipment (UE).

In an example, determining a QoS profile associated with a QoS flow includes selecting a QoS profile (e.g., alternative QoS profile) for an existing QoS flow or selecting a QoS profile for a newly admitted QoS flow.

In an example, the determining of a QoS profile is triggered based on an energy-related event in the wireless communications network.

In an example, the determining of a QoS profile is triggered based on the requirements of a current QoS profile not being met.

In an example, the determining of a QoS profile is triggered based on an energy requirement of a current QoS profile.

In an example, the determining of a QoS profile is performed by the one or more network entities, and wherein the one or more network entities includes one or more of a radio access network (RAN), a session management function (SMF), an access and mobility management function (AMF), and a policy and charging control (PCC) entity.

In an example, the energy information includes information on one or more of energy consumption parameters, energy monitoring, energy performance metrics, energy thresholds, energy upper and lower bounds, energy (consumption) maximum or minimum, and/or other energy related parameters and/or information.

In an example, the energy information includes one or more of a maximum energy threshold, a maximum energy threshold plus or minus a delta value, a maximum energy threshold and a given time duration, a maximum threshold and a maximum number of occurrences the actual energy used to provide a QoS level goes beyond the maximum energy threshold.

In an example, the energy information includes one or more of a minimum energy threshold, a minimum energy threshold plus or minus a delta value, a minimum energy threshold and a given time duration, a minimum threshold and a maximum number of occurrences the actual energy used to provide a QoS level goes below the minimum energy threshold.

In an example, the energy information includes one or more of an upper bound and/or lower bound, a range between maximum and minimum values and a given time duration, energy consumption measured over a period of time (e.g., time-window, or the like), an energy consumption quota, energy consumption per network entity and/or network function, energy consumption per QoS flow(s), PDU session(s), radio bearer(s), or the like), and energy consumption per location or a given area (e.g., cell, tracking area, registration area, country, or the like).

In an example, the energy information is associated with at least one of the UE, the one or more network entities, a network function, and a QoS profile.

In an example, at least some of the energy information is included in subscriber information associated with the UE or a group of UEs including the UE.

In an example, the method further includes determining QoS profile(s) for one or more QoS flows associated with the UE or the group of UEs based on the subscriber information.

In an example, the energy information includes information on an energy consumption of a RAN of the wireless communications network.

In an example, the energy information includes a maximum energy for providing a QoS profile (i.e., treating a QoS flow in accordance with the QoS profile).

In an example, obtaining the energy information includes receiving the energy information by a RAN of the wireless communications network from a core network entity of the wireless communications network.

In an example, the energy information is included in an energy profile and/or an alternative energy profile.

In an example, the energy profile and/or the alternative energy profile is associated with the QoS flow and/or the UE.

In an example, the energy information is included in a QoS profile and/or an alternative QoS profile.

In an example, the method further includes the UE and the one or more network entities exchanging information indicating support for QoS profile determination based on energy information.

In accordance with another aspect of the disclosure, a network entity in a wireless communication network is provided. The network entity includes a transceiver and a processor coupled with the transceiver and configured to obtain energy information associated with the wireless communications network, and determine, based on the energy information, at least one of a quality of service (QoS) profile associated with a QoS flow of the wireless communications network and a QoS profile associated with a UE.

In accordance with another aspect of the disclosure, a method for a radio access network (RAN) for a wireless communications network is provided. The method includes obtaining energy information associated with the wireless communications network, and determining, based on the energy information, at least one of a QoS profile associated with a QoS flow of the wireless communications network and a QoS profile associated with the UE.

In accordance with another aspect of the disclosure, a radio access network (RAN) for a wireless communication network, wherein the RAN is configured to implement the method, is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the disclosure provide one or more techniques, profiles and/or frameworks related to selecting QoS profiles based on energy considerations, for example in a 3GPP 5G NR network. However, the skilled person will appreciate that the disclosure is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of an NG-RAN node (e.g., a base station, evolved node B (eNB) or next generation node B (gNB)) in the examples below may be applied to any other suitable type of entity performing RAN functions; and/or the functionality of an AMF entity in the examples below may be applied to any other suitable type of entity performing access and mobility management functions.

A particular network entity may be implemented as a network element on a dedicated hardware, as a software instance running on a dedicated hardware, and/or as a virtualised function instantiated on an appropriate platform, e.g., on a cloud infrastructure.

The skilled person will appreciate that the disclosure is not limited to the specific examples disclosed herein. For example:

The techniques disclosed herein are not limited to 3GPP 5G. For example, the techniques disclosed herein may be applied to 3GPP 5G-advanced or 6G, and/or any existing and/or future 3GPP Release (e.g., Rel-19, 20, or the like), and/or any suitable non-3GPP technology.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements or entities may be added to the examples disclosed herein.

One or more non-essential elements or entities may be omitted in certain examples.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed and/or the order in which messages are transmitted may be modified, if possible, in alternative examples.

Certain examples of the disclosure may be provided in the form of an apparatus/device/network entity configured to perform one or more defined network functions and/or a method therefor. Certain examples of the disclosure may be provided in the form of a system (e.g., network or wireless communication system) comprising one or more such apparatuses/devices/network entities, and/or a method therefor.

### Lack of QoS Profile (or Alternative QoS Profile) Selection Based on Energy Constraint (or Consideration)

As described above, the 3GPP have addressed the case of the NG-RAN selecting an alternative QoS profile in the case that it cannot fulfil the original QoS profile for a given QoS Flow in terms of resources. However, the NG-RAN does not consider any energy implications (e.g., energy constraints, requirements, consumption, cost, energy resources, or the like) that are associated with the selection (or modification) of QoS profile (or Alternative QoS profiles) for a given QoS Flow. For example, the NG-RAN may not take into consideration energy impact due to selection of a QoS profile e.g., either the initial profile or the alternative QoS profile for the data flow and/or the UE. For example, the NG-RAN may notify the network that it is able to fulfil an alternative QoS profile X, with specific QoS requirements, for the QoS flow, without taking into consideration whether this QoS profile would require a higher energy consumption from the NG-RAN. For example, the NG-RAN may fulfil the alternative QoS profile but exceeds any energy consumption (threshold, bounds, maximum values, energy ranges and/or energy quota) of the NG-RAN (and/or any other network entity involved in this QoS flow(s)) that needs to be kept at (or under) a given value(s). This may carry the risk that the QoS flow(s) is (are) released in case of exceeding the energy consumption limitations (and/or other energy related parameters). This could lead to delays and further energy consumption due to re-admitting the released QoS flow(s) and/or admitting new QoS flow(s).

As another example, the NG-RAN may be using a first QoS profile to serve a QoS Flow in question, where this profile may lead to the consumption of a certain energy resource. The overall energy consumption in the NG-RAN may increase beyond an acceptable level. As such, maintaining a particular QoS profile for the UE may not be possible due to the QoS profile's energy requirements. As such, the network may need to use an alternative QoS profile. However, there is currently no such consideration based on energy levels.

In the following solutions are introduced that ensure or allow the network (e.g., NG-RAN, SMF, AMF, PCC, or the like) to take into consideration energy consumption (of one or more network entities and/or functions) when assigning (and/or modifying the assigned and/or adopted and/or selected) QoS profile (and/or QoS parameters and/or QoS requirements) for QoS flow(s).

In view of the above-mentioned shortcomings, the following approaches are proposed by the disclosure;

The network defines a new class (or type or category) of QoS profile and/or Alternative QoS profiles based on energy consumption.

The network may include this information as part of the subscriber information.

The network may inform another network entity and/or the UE of the new class of QoS profiles and/or alternative QoS profiles available for a given QoS flow (or flows).

The new concept of energy profile (EP) and/or alternative energy profile (AEPs);

The new concept of alternative QoS profile based on energy consideration (AQPE).

The network controls the selection of QoS profile(s) and/or alternative QoS profile(s) based on energy consideration.

The use of the defined EPs, AEPs and AQPEs for the selection of (or modification of the selected or assigned or chosen or (pre-) configured, or the like) QoS profile(s) and/or the alternative QoS profile(s) for QoS flow(s).

Signalling, messages, and/or procedures required to use and/or exchange the defined EPs, AEPs and AQPEs.

The UE and the network capability to support the new features of energy profile and/or alternative energy profile(s) (e.g., for a given QoS flow(s)).

The UE and the network may exchange their capability to support the new features of energy profile and alternative energy profiles (e.g., for a given QoS flow(s)).

The UE capability to support the new feature of selection (or modification of the selected or assigned or (pre-) configured, or the like) QoS profile (and/or alternative QoS profiles) for a given QoS flow, based on energy consideration.

The UE may indicate (or report) to the network it is capability to support the selection of QoS profile (and/or alternative QoS profile) for a QoS flow, based on energy consideration, using existing and/or newly defined UE capability reporting (e.g., via radio resource control (RRC) and/or non-access stratum (NAS) signalling, any other suitable signalling/messages).

The network capability to support the new feature of selection (or modification of the selected or assigned or (pre-) configured, or the like) QoS profile (and/or alternative QoS profiles) for a given QoS flow, based on energy consideration.

The UE may indicate (or report) to the network it is capability to support the selection of QoS profile (and/or alternative QoS profile) for a QoS flow, based on energy consideration, using existing and/or newly defined UE capability reporting (e.g., via RRC and/or NAS signalling, any other suitable signalling/messages).

Further detail related to these proposals is provided below. It should be noted that all the proposals apply to 5GS, and/or any other system, such as 3^{rd} generation (3G), 4^{th} generation (4G), 6G, or the like. Furthermore, the proposals herein that require interactions between the core network and the RAN would apply to all cases i.e., for 3GPP RAN and non-3GPP RAN.

### Energy Profile (EP) or Alternative Energy Profile (AEPs) for QoS Flow(s)

Here the newly proposed concept of an energy profile (or Alternative energy profile that may (or may not) be associated with QoS profile (i.e., QoS profile, QoS requirements, QoS characteristics, other QoS parameters) is described.

Energy profile may be defined to contain a desired energy level where this profile may be associated with a QoS profile (and/or alternative QoS profile) or a certain QoS flow which in turn is known to be characterized by certain treatment or handling. The QoS flow may be GBR, non-GBR, Delay-critical GBR, or the like.

The energy profile may be implemented in any form, such as:

A new set of parameter or information, which has an energy level and then an energy level is optionally associated with a QoS treatment (and/or QoS characteristics and/or QoS requirements, or the like). This may be one or more entries of energy levels each of which may be associated with a QoS flow or QoS profile (and/or alternative QoS profile).

Alternatively, the existing QoS profiles (and/or alternative QoS profiles) may be updated to contain an energy level.

Regardless of the implementation, the concepts here would apply in any way

The energy profile may contain other information or may represent different parameters, such as:
Maximum threshold
Maximum threshold+/− (plus or minus) a delta value
Maximum threshold and a given time duration
Maximum threshold and an integer N, where N represents the maximum number of occurrences that the actual energy used to provide a QoS level goes beyond the maximum energy level or threshold

The energy profile may contain other information or may represent different parameters, such as:
Minimum threshold
Minimum threshold+/− (plus or minus) a delta value
Minimum threshold and a given time duration

Minimum threshold and an integer N, where N represents the maximum number of occurrences that the actually energy used to provide a QoS level goes below the Minimum energy level or threshold.

The energy profile may contain other information or may represent different energy consumption parameters, such as:
Upper bound and/or Lower bound
Range between Maximum and Minimum values and a given time duration
Energy consumption measured over a period of time (e.g., time-window, or the like)
Energy consumption quota
Energy consumption per network entity (and/or network function)
Energy consumption per QoS flow(s), PDU session(s), radio bearer(s), or the like.

Energy consumption per location (or a given area), e.g., cell, tracking area, registration area, country, or the like.

The energy profile may be used to determine the QoS treatment as will be explained. For example, when the NG-RAN determines that an event related to energy has occurred, then the NG-RAN may use the energy profile to determine the QoS treatment for a flow. This can happen at admission or after a flow is admitted and hence a modification of the treatment may occur.

Alternative Energy profile may be defined to contain a desired energy level where this profile may be associated with a QoS profile (and/or alternative QoS profile) or a certain QoS flow which in turn is known to be characterized by certain treatment or handling. The QoS flow may be GBR, non-GBR, Delay-critical GBR, or the like.

In this disclosure (as a whole or in part), all examples on implementation, content, and/or other treatments related to the energy profile may also apply (as a whole or in part or separately) to the concept of alternative energy profile.

Note that herein the term energy level may also refer to other energy consumption parameters and information that is mentioned in this disclosure (as a whole or in part) in relation to the energy profile (and/or alternative energy profile). Also note that hereafter the mention of QoS treatment may also refer to QoS requirements or QoS profile or alternative QoS profile for the QoS flow in question.

It is proposed to define (and/or assign) a set of (one or more) energy profiles (EPs) and/or a list of alternative energy profile(s) (AEPs) for a set of (one or more) QoS flows. This may be defined in the network e.g., the NG-RAN or any other network entity. For example, each QoS profile may be associated with a certain energy level, where the energy level may by any of the following:

The maximum energy level or maximum energy threshold that an entity e.g., NG-RAN, should use to provide the QoS profile or to treat a QoS flow based on the QoS profile. This represents the maximum energy level that should be consumed optionally for the corresponding QoS profile that is associated with this energy level. As such, if the energy level which is used for providing the associated QoS treatment goes beyond this threshold, then the network may consider this as a trigger or event for determining a different QoS treatment for the QoS flow in question or for the UE in question

The maximum energy level, plus or minus a delta level/value, that an entity e.g., NG-RAN, should use to provide the QoS profile or to treat a QoS flow based on the QoS profile. However, it can be assumed that the energy level should not, for example, exceed (or not more than) the level plus the delta value which is associated with the level. If the actual energy used exceeds the total of ‘maximum plus delta level’, then the network entity e.g., NG-RAN may consider this as a trigger or event to determine a new QoS treatment for the QoS flow in question or for the UE in question

The maximum energy level that an entity e.g., NG-RAN, should use to provide the QoS profile or to treat a QoS flow based on the QoS profile, where the energy level actually used may potentially exceed (or be more than) this maximum but should not do so beyond a known time T (or time window W). For example, this information may mean that if the actual energy level used in association with a particular QoS level exceeds the known maximum threshold, the entity e.g., NG-RAN, may verify (e.g., by starting a timer) if the energy being used to provide the QoS treatment goes beyond the threshold for the associated maximum time T (or a time window W). If yes, then the entity, e.g., NG-RAN, may consider this is a trigger or event to determine to use an alternative QoS profile (for the QoS flow or for the UE in question). For example, where the alternative QoS profile may be associated with an energy level, which is less than the current selected QoS profile. For example, if the entity e.g., NG-RAN uses an energy level beyond the threshold but the use of the extra energy happens within a time limit that is less than T, then the entity e.g., NG-RAN may determine to maintain the current QoS profile.

The network, e.g., NG-RAN, may determine that using the QoS profile or the alternative QoS profile(s), for example, assigned (or associated) with the lowest energy level may still exceed the maximum energy level for the time T (or less than the time T, or the time window W), then the NG-RAN (and/or the network entity(s)) may decide to release (or trigger release or command release or request to release) this QoS flow. Additionally, the network entity that releases the QoS flow may indicate to at least one other network entity (and/or network function and/or the UE), that is involved in the QoS flow, the reason for this release, e.g., may include a cause value for the QoS flow release (e.g., exceed energy level, or energy consideration, and/or any other suitable naming of cause value).

The minimum energy level that an entity e.g., NG-RAN, should use to provide the QoS profile (or alternative QoS profile) or to treat a QoS flow based on the QoS profile (or alternative QoS profile). If the actual energy used goes below this minimum value, then the network entity e.g., NG-RAN may consider this to be a trigger or event to determine a new QoS treatment for the QoS flow in question or for the UE in question.

The minimum energy level, plus or minus a delta level/value, that an entity e.g., NG-RAN, should use to provide the QoS profile (or alternative QoS profile) or to treat a QoS flow based on the QoS profile (or alternative QoS profile). However, it can be assumed that the energy level should not, for example, be less than the energy level minus the delta level/value which is associated with the energy level.

The minimum energy level that an entity, e.g., NG-RAN should use to provide the QoS profile (or alternative QoS profile) or to treat a QoS flow based on the QoS profile (or alternative QoS profile), where the energy level actually used may potentially be less than this minimum but should not do so beyond a known time T (or time window W). For example, this information may mean that if the actual energy level used in association with particular QoS requirement(s) goes below the known minimum threshold, the entity e.g., NG-RAN, may verify (e.g., by starting a timer) if the energy being used to provide the QoS treatment goes below the threshold for the associated maximum time T. If yes, then the entity, e.g., NG-RAN, may determine to use an alternative QoS profile e.g., where the alternative QoS profile (or QoS profile) may be associated with an energy level which is more than the current selected QoS profile (or alternative QoS profile). For example, if the entity e.g., NG-RAN uses an energy level below the threshold but the use of the less energy happens within a time limit that is less than T (or a time window that is less than W), then the entity e.g., NG-RAN may determine to maintain the current QoS profile (or alternative QoS profile). In another example, the network entity, e.g., NG-RAN may decide to use an alternative QoS profile (or QoS profile), if the NG-RAN determines that this alternative QoS profile (or QoS profile) may (or is predicted to) result in a lower energy level (or energy consumption) for time that exceeds the time limit T (or the time window W).

Note that herein the term energy profile and alternative energy profile may be used in the same way or different ways in relation to QoS profile and alternative QoS profiles for QoS flow(s).

The network may assign (or allocate or modify) the EPs and/or AEPs for a set of (one or more) QoS flows based on information provided as part of the subscriber information.

The network may assign (or allocate or modify) the EPs and/or AEPs for all QoS flows admitted or to be admitted to the network at a given location and/or time.

In another example, the network may assign (or allocate or modify) the EPs and/or AEPs for all or some (or one) of QoS flow(s) or set of (one or more) QoS flow(s) that belong to one (or a group of) UE(s).

The network may use assistance information from the application function, server, service provider, and/or any other eternal and/or external network entity (and/or function) to assign (or selected or decided or allocate, or modify) the EPs and AEPs for a give QoS flow (or QoS flows).

The network may assign (or modify) the EPs and/or AEPs for selected UEs or UEs types or UE with specific capabilities, e.g., UE capabilities to support the EP and AEPs features for energy consideration on QoS flow(s), QoS flow(s) of PDU session(s), data radio bearer(s) (DRB(s)), and/or slice(s).

The network may assign to UEs that have the capability to support allocation of QoS profile and/or Alternative QoS profiles under energy considerations. Optionally, general capability to support QoS profile and alternative QoS profiles based on energy consideration and/or QoS flow type specific capability, e.g., capability to support QoS profile and/or Alternative QoS profiles allocation based on type GBR QoS flow, delay-critical GBR QoS flow, non-GBR QoS flow, and/or any other QoS flow type.

In one example, the QoS flow may be of type GBR QoS flow, delay-critical GBR QoS flow, non-GBR QoS flow, and/or any other QoS flow type.

In one example, the set of EPs and/or AEPs can be extended to QoS flows in a set of (one or more) PDU sessions(s), a set of (one or more) DRBs, and/or a set of (one or more) slices.

In one example, the network may define (and/or assign or modify) the EPs and/or AEPs in relation to QoS profile and/or the list of alternative QoS profile for a QoS flow (or QoS flows). For example, in the list of EPs (and/or list of alternative EPs) profiles, Energy Profile #1 is assigned to QoS Profile #1 (and/or list of alternative QoS Profiles), or any other mapping between QoS profile, list of alternative QoS profiles, EP(s), and/or list of AEPs. As such, a QoS profile may be associated with at least an energy profile and may include other information as proposed above e.g., maximum time duration for which an energy level may go beyond the maximum energy threshold of the associated QoS profile.

In an alternative example, the network may define (and/or assign or modify) the EPs, list of AEPs for QoS flow(s), separately from (or not in relation to, or based on, or in separate lists to) the QoS profile and/or the list of alternative QoS profiles for the QoS flow (or QoS flows).

In one example, the network may not assign any EPs and/or AEPs for a specific set (one or more) of QoS flows, e.g., based on QoS flow type, e.g., type GBR QoS flow, delay-critical GBR QoS.

In an example, the SMF/AMF may provide the EP and/or list of AEPs to the NG-RAN (and/or another network entity involved in the QoS flow(s)). Optionally, the NG-RAN stores the list of AEPs.

In another example, the SMF/AMF may provide, in addition to the QoS profile and the alternative QoS profiles, the EP(s) and/or list of AEPs to the NG-RAN. Optionally, the NG-RAN stores all (or part of) the previous profiles and lists.

In a related example, the SMF/AMF provides EP(s), and/or a new list of AEPs to the NG-RAN (and/or another network entity involved in the QoS flow(s)), if the corresponding PCC rule information changes and/or subscription information changes, the NG-RAN shall replace any previously stored list with the new list of AEPs.

An EP or AEP represents a combination of energy consumption parameters, energy monitoring, energy performance metrics, energy thresholds, energy upper and lower bounds, energy (consumption) maximum or minimum, and/or other energy related parameters and/or information.

In one example, the network (e.g., SMF/AMF, PCC, NG-RAN, or the like) may allocate an EP that corresponds to or ensures the QoS requirements in the given (or related) QoS profile. In another example, the EP corresponds to the normal operation of the QoS, i.e., not under normal energy consumption rules in the network, e.g., network entities (e.g., NG-RAN, or the like) operating within its energy quota, energy consumption bounds or less than the maximum energy consumption thresholds.

In one example, the network (e.g., SMF/AMF, PCC, or the like) may allocate a list of AEP that the NG-RAN can select from, rather than using the normal EP, to operate the QoS flow (or flows) in the case of energy operation (or conditions) different to the normal energy operation (or conditions). In one example, the list of AEPs may contain degraded (or reduced levels) of allowed energy consumption in relation to the operation of the given QoS flow (or flows). In another example, the list of AEPs contain, AEP1={Energy consumption Level 1}, AEP2={Energy consumption Level 2}, AEP3={Energy consumption Level 3}, AEPX={Energy consumption Level X}, where: Energy consumption for the QoS flow in EP>AEP1>AEP2>AEP3>AEPX.

In one example, the NG-RAN notifies the network (e.g., SMF/AMF, or the like) of the selection of alternative EP(s) for a QoS Flow. Optionally, the NG-RAN indicates the reason for changing or modifying from the EP to alternative EP(s) for a given QoS flow (or flows) due to the change in energy consumption situation (or conditions) in the NG-RAN (and/or another network entity involved in the operation of the QoS flow (or flows), and/or the UE(s)).

In another example, the NG-RAN sends a notification to the SMF/AMF that the EP (i.e., energy requirements or energy considerations) for the QoS profile (or profiles) is (are) not fulfilled, the NG-RAN shall, if the currently fulfilled values match an Alternative EP, include also the reference to the Alternative EP to indicate the EP (i.e., energy requirements or energy considerations) that the NG-RAN currently fulfils. The NG-RAN shall enable the SMF to determine when an NG-RAN node supports the Alternative EP feature but cannot fulfil even the least preferred Alternative EP Profile. The SMF may then perform a PDU session modification procedure with the UE in order to indicate an alternative QoS that is associated with the energy level or with the indicated EP (e.g., received from the NG-RAN).

In one example, to reduce the risk that QoS flows are released in case of limited energy resources (or high energy consumption) in the RAN (and then experience difficulties in being re-established), the network (and/or application functions) can set the least preferred Alternative EP (i.e., energy requirements) to lowest energy consumption level that still guarantees the QoS requirements, or acceptable degradation in QoS requirements the given QoS flow (or flows). This degradation (whether acceptable or not) may depend on the service requirements of the QoS flow (or flows). In one example, using an AEP that corresponds to a degraded (or reduced) QoS flow requirements for non-GBR flows.

New NG-RAN Behaviour with Regards to the Energy Profile

Here a new NG-RAN behaviour with respect to the proposed energy profile is described. Currently, resource consideration to admit or modify QoS flows does not consider energy. As such this disclosure proposes that energy should be considered when determining the QoS treatment of a flow-either at admission or after admission of a QoS flow.

For example, on one solution is that energy is used as an input into a determination function, where the output of this function is the QoS treatment for a QoS flow or for a UE or for a PDU session. The disclosure proposes the idea with some examples, however other ways to achieve this may be possible e.g., where energy is considered along with other parameters in order to determine the QoS treatment for a QoS flow.

The NG-RAN is assumed to know the energy level for a QoS treatment, for example, the NG-RAN is configured with information about the energy level that a particular QoS treatment is associated with, or how much energy level a particular QoS treatment should consume, or how much energy the NG-RAN (and/or other network entities and/or network functions) should use (or consume) to provide a particular QoS treatment for the QoS flow or the UE in question. Other ways for this information to be provided (or available) at the NG-RAN will be described in the next section.

The proposals apply either at admission of a QoS flow or when an event/trigger occurs such that the NG-RAN determines that the QoS treatment of an already admitted QoS flow should be modified. Hereafter, any of this may be referred to as determining a new energy profile (or alternative energy profile) for a QoS flow. As such, determining a new energy profile can also mean that a new QoS treatment can be determined and its associated energy level or consumption (or usage) should be determined and/or monitored accordingly.

The following are example NG-RAN proposals, behavior and triggers for determining a new energy profile for a QoS flow:

Admission of a new QoS flow

For an already admitted QoS flow, any of the following events may lead to determination of a new energy profile:

For each of the defined parameter in the first section, list how the parameter(s) can be used as an event

Here is what we need to explore different ideas and events

When the NG-RAN determines to select a new energy profile, e.g., after any of the previous events occur (in any combination or order), the NG-RAN behaves as follows:

Select a new energy level e.g., based on the UE, system, number of UEs divided by total energy, or the like.

Match the selected energy level with the energy level of the possible energy profiles

When a match is detected, determine to apply the associated QoS treatment of the matched QoS profile (or alternative QoS profile)

Perform RRC procedure towards the UE and configure the UE with the necessary information and/or parameters to match the determined new QoS treatment

Inform the SMF (and/or AMF) or any other CN entity about the new QoS treatment that has been determined and/or applied and/or used, include a cause value related to energy

In one option, SMF may perform PDU session modification to use the new QoS treatment that is indicated by the NG-RAN

### Method to Determine the Energy Profile

Here some examples of how the NG-RAN may determine the energy profile are proposed.

The NG-RAN is preconfigured with this information.

It is proposed to define standardized energy profile and so the NG-RAN knows the standardized energy profiles and their respective QoS treatment. For example, a standardized QoS flow treatment (e.g., 5QI value) would have a standardized energy profile that is known in the NG-RAN. Furthermore, the NG-RAN may also be configured with energy profile to use even for non-standardized QoS flows or for 5QIs with non-standardized values. As such, when the NG-RAN uses a particular QoS treatment e.g., 5QI or other QoS profile parameters, the NG-RAN can determine the energy level to use based on this information that the NG-RAN has or is preconfigured with. Note that all the previous parameters which are defined can be assumed to be known or available either based on preconfigured information or new defined profiles as described above

Using operation, administration and maintenance (OAM). The NG-RAN may be provided with the proposed energy profile based on OAM

NG-RAN receives the energy profile information from any CN node e.g.,

New subscription info can be defined and the NG-RAN may be provided with this information via any core network node, such as the AMF or the SMF

Another CN entity provides this info to the NG-RAN

The SMF provides this info to the NG-RAN during PDU session establishment or modification (or using any existing or new message or IE that is exchanged between the SMF and NG-RAN)

For any of the above, the energy profile may be per UE or per QoS flow or per QoS profile or for all UEs, or any other association may be used e.g., based on service type or UE access category, or the like.

At any point in time, the NG-RAN may receive new or updated energy profile using any of the mechanisms above. Any updates in the energy profile can lead to the NG-RAN determining a new energy profile for a QoS flow or a UE in question.

The proposals herein may be applied for any of the following, in any order or combination, for example.

The NG-RAN may start the consideration of energy level (or energy profile) for the selection (or assigning) of QoS profile (or alternative QoS profile) for the QoS flow in question. In another example, consideration of energy level (or energy profile), for determining whether to replace (or keep or maintain) an assigned QoS profile (or alternative QoS profile) with another alternative QoS profile for the QoS flow in question (e.g., already admitted QoS flow), or when an event or trigger for determining a new energy profile occurs. In another example, replace an assigned alternative QoS profile with the QoS profile for the QoS flow in question, also based on energy consideration (or energy profile or energy level)

Based on the configuration in the NG-RAN e.g., to start considering energy as a criterion for selection of QoS profile (or alternative QoS profile(s)) for the QoS flow in question.

For all UEs

For all UEs on a particular slice, where the slice may be known to the NG-RAN

For UEs in a certain location, at a certain time

For all UEs (or a selected group of UEs) of a certain category (or type) and/or capability

When the energy usage in the NG-RAN exceeds a certain energy level, or when the NG-RAN determines to apply procedures for energy savings or energy efficiency. This may be based on OAM or based on an indication from any other core network entity, such as, but not limited to, the AMF.

The NG-RAN may stop (fully or partially) or pause the consideration of energy level (or energy profile) for the selection (or assigning) of QoS profile (or alternative QoS profile) for the QoS flow in question. In another example, consideration of energy level (or energy profile) for determining whether to replace (or keep or maintain) an assigned QoS profile (or alternative QoS profile) with another alternative QoS profile for the QoS flow in question (e.g., already admitted QoS flow), or when an event or trigger for determining a new energy profile occurs. In another example, replace an assigned alternative QoS profile with the QoS profile for the QoS flow in question, also based on energy consideration (or energy profile or energy level)

Based on the configuration in the NG-RAN e.g., to stop considering energy (or energy profile or energy level) as a criterion for selection of QoS profile (or alternative QoS profiles) for a given

For all UEs

For all UEs on a particular slice, where the slice may be known to the NG-RAN

For UEs in a certain location, at a certain time

When the energy usage in the NG-RAN goes below a certain threshold

When the NG-RAN is informed to stop considering energy (or energy profile or energy level, or the like) in the selection of QoS profile (or alternative QoS profiles) for a given QoS flow by any network function such as, but not limited to, an AMF (or SMF, or the like), either directly or via another network entity.

Other examples, similar to those mentioned earlier for the case of start the consideration of energy (or energy profile or energy level) to select (or modify or change or keep, or the like) the QoS profile (or alternative QoS profile) for an existing and/or new admitted QoS flow(s).

All of the proposals herein apply to other QoS flow operations e.g., to modify an existing QoS flow, and therefore the proposals are not restricted only to admission of QoS flows.

Moreover, the NG-RAN may modify or replace assigned (or allocated or chosen or configured, or the like) QoS profile (and/or alternative QoS profile(s)) for QoS flow(s) taking into consideration of energy consumption level. In another example, taking into consideration the assigned (or determined or configured) energy profile (and/or alternative energy profile(s)) and/or energy level, or the like).

The NG-RAN may prioritise one or more alternative QoS profile (e.g., out of the list of QoS profiles) allocated to QoS flow(s) based on the energy level (and/or energy profile and/or alternative energy profile) for the QoS flow(s).

In another alternative, the NG-RAN may prioritise one or more energy profile(s) and/or alternative energy profiles(s) (e.g., say from a list of alternative energy profiles).

### Further Examples

The network defines (and/or assigns) a set of (one or more) QoS profiles and/or a set of (one or more) Alternative QoS profiles based on energy considerations for a set of (one or more) QoS flows. In one example, the QoS flow may be of type GBR QoS flow, delay-critical GBR QoS flow, non-GBR QoS flow, and/or any other QoS flow type.

The network may define (and/or assigns) a set of (one or more) QoS profiles and/or a set of (one or more) Alternative QoS profiles based on energy considerations for a set of (one or more) QoS flows, based on information provided as part of the subscriber information.

The network may define (and/or assigns) a set of (one or more) QoS profiles and/or a set of (one or more) Alternative QoS profiles based on energy considerations for a set of (one or more) QoS flows, for selected UEs or UEs types or UE with specific capabilities, e.g., UE capabilities to support the EP and AEPs features for energy consideration on QoS flow(s), QoS flow(s) of PDU session(s), DRB(s), and/or slice(s).

In another example, the network may assign (or allocate) define (and/or assigns) a set of (one or more) QoS profiles and/or a set of (one or more) Alternative QoS profiles based on energy considerations for a set of (one or more) QoS flows that belong to one (or a group of) UE(s).

The network may define (and/or assigns) a set of (one or more) QoS profiles and/or a set of (one or more) Alternative QoS profiles based on energy considerations, for a set of (one or more) QoS flows all QoS flows admitted or to be admitted to the network at a given location and/or time.

In one example, the energy consideration can be extended to QoS flows in a set of (one or more) PDU sessions(s), a set of (one or more) DRBs, and/or a set of (one or more) slices.

The network may assign to UEs that have the capability to support allocation of QoS profiles and/or Alternative QoS profiles under energy considerations. Optionally, general capability to support QoS profile and alternative QoS profiles based on energy consideration and/or QoS flow type specific capability, e.g., capability to support QoS profile and/or Alternative QoS profiles allocation based on type GBR QoS flow, delay-critical GBR QoS flow, non-GBR QoS flow, and/or any other QoS flow type.

The network may extend allocation of QoS profile(s) and/or Alternative QoS profiles based on energy considerations to QoS flows in a set of (one or more) PDU sessions(s), a set of (one or more) DRBs, and/or a set of (one or more) slices.

In one example, the network may define (and/or assign) the QoS profile and/or the list of alternative QoS profile for a QoS flow (or QoS flows) based on energy consideration in the network (or a network entity). For example, the QoS profile and/or the list of alternative QoS profiles is selected (or decided) by the network taking into consideration the energy consumption related to the given QoS flow (or flows). In other words, the energy consumption value(s) assigned to QoS profile #1 (and/or list of alternative QoS profiles), or any other mapping between energy consumption value(s), QoS profile(s) and/or list of alternative QoS profiles.

The network may not assign any energy consideration (i.e., energy consumption control) for a specific set of QoS flows, or QoS flows types, e.g., GBR QoS flows or non-delay tolerant GBR QoS flows.

In an example, the SMF may provide, to the NG-RAN (and/or another network entity involved in the QoS flow(s)), QoS profile and/or a list of AEPs that are based on energy consideration, for example, allocated energy consumption information related to the QoS flow(s). Optionally, the NG-RAN stores the QoS profile and/or list of Alternative QoS profiles that are based on energy considerations.

In a related example, the SMF provides a QoS profile and/or a list of AEPs that are based on energy consideration to the NG-RAN (and/or another network entity involved in the QoS flow(s)), if the corresponding PCC rule information changes and/or subscription information changes, the NG-RAN shall replace any previously stored list with the new QoS profile(s) and/or list of alternative QoS profile(s) that are based on energy considerations.

Energy considerations refer to represents a combination of energy consumption parameters, energy monitoring, energy performance metrics, energy thresholds, energy upper and lower bounds, energy (consumption) maximum or minimum, and/or other energy related parameters and/or information.

The NG-RAN and the network (e.g., SMF) have similar behaviour, as mentioned in previous sections, such as confirmation and/or indication of the use of a QoS profile and/or alternative QoS profile that is based on energy considerations.

The proposed aspects of this disclosure set out below can be exchanged between the UE and/or the network entity (e.g., NG-RAN, SMF, AMF, other network entity and/or function), can be exchanged using existing and/or newly defined RRC and/or NAS signalling/messages. In another example, those information may be provided via system information broadcast (e.g., periodically or on-demand, or the like) and/or dedicated system information. In another example, provided using an existing and/or newly defined system information block (SIB).
Energy profile, alternative energy profile(s)
QoS profile(s) under energy consideration,
Alternative QoS profile(s) under energy consideration,
Related energy and QoS requirements, parameters and/or information
Indication (or reporting), for example, of UE capability and/or network capability to support those new aspects
Any other parameters and information introduced in this disclosure

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

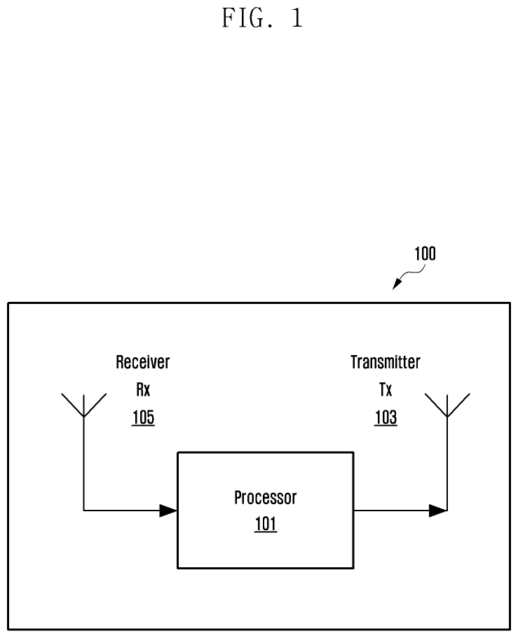

FIG. 1 is a block diagram of a network entity (e.g., AMF entity, base station and/or any other network entity) according to an embodiment of the disclosure.

The skilled person will appreciate that a network entity may be implemented, for example, as a network element on a dedicated hardware, as a software instance running on a dedicated hardware, and/or as a virtualised function instantiated on an appropriate platform, e.g., on a cloud infrastructure.

Referring to FIG. 1, an entity 100 comprises a processor (or controller) 101, a transmitter 103 and a receiver 105. The receiver 105 is configured for receiving one or more messages from one or more other network entities, for example as described above. The transmitter 103 is configured for transmitting one or more messages to one or more other network entities, for example as described above. The processor 101 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like read only memory (ROM), whether erasable or rewritable or not, or in the form of memory, such as, for example, random access memory (RAM), memory chips, device or integrated circuits or on an optically or magnetically readable medium, such as, for example, a compact disc (CD), digital versatile disc (DVD), magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network entity in a wireless communications network, the method comprising:
obtaining energy information associated with the wireless communications network; and
determining, based on the energy information, at least one of a quality of service (QoS) profile associated with a QoS flow of the wireless communications network and a QoS profile associated with a user equipment (UE).

2. The method of claim 1, wherein the determining of the QoS profile associated with the QoS flow includes selecting a QoS profile for an existing QoS flow or selecting a QoS profile for a newly admitted QoS flow.

3. The method of claim 1, wherein the network entity includes one or more of a radio access network (RAN), a session management function (SMF), an access and mobility management function (AMF), and a policy and charging control (PCC) entity.

4. The method of claim 1, wherein the energy information includes one or more of a maximum energy threshold, a maximum energy threshold plus or minus a delta value, a maximum energy threshold and a given time duration, a maximum threshold and a maximum number of occurrences the energy used to provide a QoS level goes beyond the maximum energy threshold.

5. The method of claim 1, wherein the energy information is included in subscriber information associated with the UE.

6. The method of claim 1, wherein the energy information includes information on an energy consumption of a RAN of the wireless communications network.

7. The method of claim 1, wherein the energy information includes a maximum energy for providing a QoS profile.

8. The method of claim 1, wherein the obtaining of the energy information includes receiving the energy information from a core network entity of the wireless communications network.

9. A network entity in a wireless communications network, the network entity comprising:
a transceiver; and
a processor coupled with the transceiver and configured to:
obtain energy information associated with the wireless communications network, and
determine, based on the energy information, at least one of a quality of service (QoS) profile associated with a QoS flow of the wireless communications network and a QoS profile associated with a user equipment (UE).

10. The network entity of claim 9, wherein the processor is further configured to when, determine the QoS profile associated with the QoS flow:
select a QoS profile for an existing QoS flow or select a QoS profile for a newly admitted QoS flow.

11. The network entity of claim 9, wherein the network entity includes one or more of a radio access network (RAN), a session management function (SMF), an access and mobility management function (AMF), and a policy and charging control (PCC) entity.

12. The network entity of claim 9, wherein the energy information includes one or more of a maximum energy threshold, a maximum energy threshold plus or minus a delta value, a maximum energy threshold and a given time duration, a maximum threshold and a maximum number of occurrences the energy used to provide a QoS level goes beyond the maximum energy threshold.

13. The network entity of claim 9, wherein the energy information is included in subscriber information associated with the UE.

14. The network entity of claim 9, wherein the energy information includes information on an energy consumption of a RAN of the wireless communications network.

15. The network entity of claim 9, wherein the energy information includes a maximum energy for providing a QoS profile.
